(19) United States
(12) Patent Application Publication
(10) Pub. No.: US 2008/0137102 A1
(43) Pub. Date: Jun. 12, 2008

(54) Device For Positioning Markings

(76) Inventors: Erhard Hoffmann, Leinfelden-Echterdingen (DE); Stefan Clauss, Stuttgart (DE); Joachim Hecht, Magstadt (DE); Christian Heine, Madrid (ES); Reiner Krapf, Reutlingen (DE); Jullian Bergmann, Stuttgart (DE)

Correspondence Address: Striker, Striker & Stenby, 103 East Neck Road, Huntington, NY, 11743, US

(21) Appl. No.: 10/587,672

(22) PCT Filed: May 3, 2005
(86) PCT No.: PCT/EP05/52016

§ 371 Date: Jul. 27, 2006

(30) Foreign Application Priority Data
Jun. 5, 2004 (DE) 10 2004 027 647.1

(51) Int. Cl. G01B 11/14

(52) U.S. Cl. 356/620

(57) ABSTRACT

The invention relates to a device for positioning markings, having a first equipment unit (10), having means (14) for disposing the first equipment unit (10) at a predeterminable first position (18) of a reference face (16), and having optical signal means (20, 22, 50, 54, 60, 62, 64, 66) for generating directional information.

According to the invention, it is proposed that the device has a second equipment unit (12, 13), which is positionable relative to the first equipment unit (10) and which has means (20, 22, 28, 50, 54, 60, 62, 64, 66), which make it possible to ascertain the spacing of the second equipment unit (12, 13) from the first equipment unit (10) in the direction predetermined by the first equipment unit.

The invention is based on a device for positioning markings as generically defined by the preamble to claim 1.

### PRIOR ART

Devices for positioning markings or for leveling markings based on a first reference marking are widely used, above all in the construction laser field. For instance, a typical object is to create two drill holes at a predetermined spacing at a predetermined level. If it is assumed that a first marking corresponds to a later, first drill hole, then for many users it is helpful to know precisely where the second drill hole should be started and drilled. This requires, after marking or drilling the first hole, determining the spacing and the location of the second or all further drill holes.

Construction lasers that can be obtained in various versions are conventional on the market. For instance, there are rotation lasers, which by means of a rotating, visible laser beam define a plane in space. Equipment with manual leveling is available, for instance via set screws or bubble levels, or partly automatic or even fully automatic leveling. With such equipment, because of this leveling, an exact horizontal or vertical orientation of the light signal can be generated.

So-called linear lasers also exist, which use a laser beam that is markedly divergent in a plane and that when it intersects the plane of a reference face projects a line onto this reference face, for instance a wall, floor, or ceiling, without requiring rotation of the laser signal.

Simple lasers with leveling capabilities are also known, such as spirit levels with a built-in laser function, which like the equipment already described can either be applied directly to foundation soil at a construction site or can be secured to rotatable auxiliary mounts and/or tripods.

Linear lasers are also known that can be secured to a wall with the aid of some auxiliary means such as a nail, screw, or drill hole insert, and can be leveled there either manually using a built-in bubble level or are self-leveling on the order of a laser pendulum. Such equipment makes it possible to project a laser beam, in the previously leveled plane, for instance onto a wall and to position appropriate markings.

From European Patent Disclosure EP 1367364 A2, a laser beam leveling device is known which can be disposed with its housing on a reference face; a pendulum is disposed in the housing and coupled pivotably to the housing and has at least one light source. The pendulum, which is subject to gravity, orients the at least one light source horizontally, so that a light signal emitted by the light source generates an exactly horizontally extending line.

### ADVANTAGES OF THE INVENTION

The device for positioning markings of the invention, hereinafter also called marking device for short, has a first equipment unit, serving as a basic part, with means for disposing this first equipment unit at a predeterminable first position of a reference face. This first equipment unit also has optical signal means for generating directional information. By means of a second equipment unit, serving as a traveling unit and positionable relative to the first equipment unit, which second equipment unit has means that make it possible to ascertain the spacing of this second equipment unit from the first equipment unit, and in particular from the predeterminable first position, it is possible to place markings exactly at a predeterminable spacing and on a predeterminable straight line.

This makes it possible for instance for a user, beginning at a first reference marking, such as a first drill hole, to make further markings quickly and exactly, for instance for further bores, at a defined spacing and in a defined horizontal or vertical location, without for instance having to use a further person or a further aid, such as a yardstick.

By the characteristics recited in the dependent claims, advantageous embodiments and refinements of the device of the invention are possible.

In an advantageous embodiment of the device of the invention, the means for determining the spacing of the second equipment unit from the first equipment unit are embodied as an optical measuring system. This can be embodied in the form of an optical distance measurement, for example. The distance measurement can for instance be done on the principle of transit time measurement, phase measurement, or the triangulation principle.

In an especially advantageous embodiment, for optically determining the spacing of the second equipment unit relative to the first equipment unit, the optical signal means of the first equipment unit, which generate directional information for the second equipment unit, are used. This can be implemented for instance by means of a light signal which extends at an angle to the reference face and which is emitted by the first equipment unit. By way of the height of the light signal relative to the reference face, if the angle is known, spacing information relative to the light source and thus to the first equipment unit can be obtained. In such a measuring system, the second equipment unit advantageously has a light-sensitive sensor, such as a linear or two-dimensional diode array, which makes it possible, from the arrival point of the optical signal means emitted by the first equipment unit, to determine the relative spacing of the second equipment unit from the first equipment unit and in particular from the first reference position on the reference face.

Advantageously, the optical signal means of the first equipment unit are formed by at least one laser, in particular a laser diode with emission in the visible spectral range. In this way, it is possible to generate readily visible, well-defined directional information for the displacement of the second equipment unit.

Advantageously, the optical signal means of the first equipment unit are embodied as self-leveling. This is implemented for instance by providing that the laser forming the optical signal means is embodied as a so-called pendulum laser in the housing of the first equipment unit and is thus self-leveling in the gravitational field, in such a way that the light emitted by the first equipment unit extends exactly horizontally.

In alternative embodiments of the device of the invention, it may be provided that the first equipment unit has means which make it possible for the optical signal means for generating the directional information to be leveled manually. To that end, the first equipment unit can be provided with one or more bubble levels, for instance, which allow the user to calibrate the first equipment unit secured to the first reference face.

In alternative embodiments of the device of the invention, it may be provided that the means for determining the spacing of the second equipment unit relative to the first equipment unit are embodied as a mechanical measuring system. The second equipment unit can for instance have wheels, rollers or roller bodies which are embodied as travel pickups and detect the travel distance covered by the second equipment unit. Furthermore, the travel pickup for the second equipment unit can also be embodied optomechanically, for instance analogously to a scrolling wheel of a computer mouse.

In a very simple and economical embodiment of the device of the invention, the second equipment unit can be implemented essentially by a measuring tape in the first equipment unit, which tape can be pulled out of the first equipment unit in the direction predetermined by the optical signal means and which thus makes it possible to ascertain the desired spacing and the location of the second marking position. This kind of measuring tape, or a measuring string that performs the same function, can for instance be present in the second equipment unit as well and can have means that permit it to secure this measuring tape or string by one end to the first equipment unit.

The device of the invention has display means in the first equipment unit and/or in the second equipment unit which permit it to reproduce the spacing value of the second equipment unit from the first equipment unit, and in particular from the first predetermined position on the reference face. Advantageously, such a display should preferably be embodied in the second equipment unit, since that is the active unit, in other words the unit that is moved by the user, and can thus be viewed directly by a user.

Advantageously, the device, and in particular the second equipment unit, has marking means which make it possible to mark a second position on the reference face. This second position corresponds to the ascertained spacing from the predeterminable first position in the direction predetermined by the first equipment unit by means of the optical signal means. Such a marking device can be embodied for instance as a die integrated with the device, particularly with the second equipment unit of the device, or as an integrated ink jet, which can generate a spot of ink on the reference face mechanically, electronically, thermally, pneumatically, or piezoceramically, for instance. A marking device of this kind can also be integrated with the second equipment unit, by means of an integrated bore, making it possible to draw or trace the precise position of the second marking using a stylus.

The device of the invention makes it possible, relative to a first, predeterminable reference marking, to make a second marking on a reference face which is located in an exactly predeterminable direction and at a defined spacing from the first predeterminable reference marking.

Further advantages of the device of the invention will become apparent from the ensuing description of several exemplary embodiments.

### DRAWINGS

In the drawings, exemplary embodiments of the device of the invention are shown which are to be described in further detail in the ensuing description. The drawing figures, their description, and the claims include numerous characteristics in combination. One skilled in the art will also consider these characteristics individually and put them together to make further useful combinations, which are thus to be likewise considered as being disclosed here.

Shown are:

FIG. 1, a first exemplary embodiment of the device for positioning markings of the invention, in a schematic top view;

FIG. 2, the exemplary embodiment of the device of the invention of FIG. 1 in a schematic front view;

FIG. 3, a second exemplary embodiment of the device for positioning markings of the invention in a schematic top view.

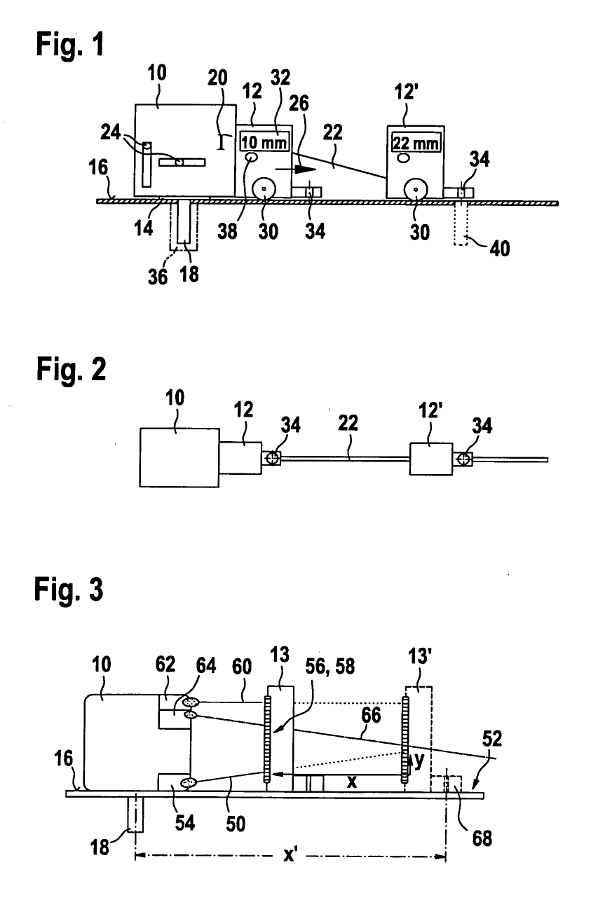

FIG. 1 shows a first exemplary embodiment of the device for positioning markings of the invention. The device comprises two equipment units. The first equipment unit 10 is formed by a stationary base unit, while the second equipment unit 12 is conversely formed by a traveling element that is positionable relative to the first equipment unit. The first equipment unit 10 is secured via a securing element 14 to a reference face 16, which may for instance be the surface of a wall, floor, or ceiling. The securing elements 14 can be connected fixedly to the first equipment unit 10 or can be connectable to it via a magnet coupling, for instance. In one embodiment of the device of the invention, the first equipment unit 10 can be introduced via a pin 18 into a bore 36, for instance in a wall. Examples of other possible mechanisms for securing the first equipment unit 10 to the reference face, besides the pin 18 shown in FIG. 1, are claws, staples, clamps, one or more nails, screws, or even adhesive or a balloon, among other options. Within the scope of this invention, the term secure elements 14 should also be understood for instance to include one or more contact points, for instance on the back side of the equipment unit 10, with which points the base element is merely pressed by a user, using his hand, against a reference face, such as a wall, and kept in position and thus “secured” to the wall.

The first equipment unit 10 has optical signal means 20, for instance a linear laser, which makes it possible to project a straight line 22 onto the surface of the reference face 16. To that end, the linear laser advantageously emits light in the visible spectral range, such as red or green light. Based on the laser line 22 projected onto the surface of the reference face 16, unambiguous directional information, originating at the first equipment unit 10, is obtained. With the aid of calibration means 24, which in the exemplary embodiment of FIG. 1 are shown schematically as bubble levels 24, the first equipment unit 10 and thus the linear laser 20 and the laser line 22 can be leveled. Besides this manual leveling of the laser line 22, it is equally possible, however, in other embodiments of the device of the invention, to provide a laser element which is embodied in a manner known per se as pendulum laser, so that the laser line 22 is leveled automatically.

The second equipment unit 12 forms an extra module that can be pulled out, which can be moved in the directional information predetermined by the laser line 22 over the surface of the reference face 16 in the direction of the arrow 26. To that end, the second equipment unit 12 has a travel pickup 28, which in the exemplary embodiment of FIG. 1, via the rollers 30 of the second equipment unit, measures the distance traveled. In a measuring operation, the second equipment unit can be moved by hand along the wall to be marked, following the laser beam 22. The rollers 30, which may for instance also be embodied as casters, detect the contact with the wall on the one hand and the distance traveled on the other. The distance traveled by the drive mechanism 12 can be forwarded to the user by means of a display 32. The display 32 can be preset such that in the event that the drive mechanism 12 has not yet been displaced, it automatically displays the spacing of its marking unit 34 from the position of a first bore 36.

Via a suitable reset function and associated switch means 38, the display 32 of the distance traveled by the drive mechanism 12 can, however, also be set by the user to the value of zero or a preset value at any time. By embodying the reset function in the second equipment unit 12, this unit can also be used without the base module 10. However, it is equally possible to automate the reset function, so that the display 32 for instance, is reset if the second equipment unit 12 contacts the first equipment unit 10.

The drive mechanism 12 can now be displaced in the directional information predetermined by the laser line 22 by a predetermined distance from its position of repose, as is indicated in FIG. 1 by the equipment unit 12′. Via the marking unit 34 on the second equipment unit 12, the position thus ascertained can for instance be marked using a scribing stylus or colored pencil. In this way, it is possible to make a second marking relative to a first reference marking, the second marking being located for instance exactly horizontally and at a defined spacing from the reference marking. At this point, once the second equipment unit 12′ has been removed, the desired second drill hole 40 can for instance be made.

FIG. 2 shows the device of the invention of FIG. 1 in a front view as it would appear to a user if he wanted for instance to do this kind of marking work on a wall that in that case would run parallel to the plane of the drawing. The second equipment unit 12 acting as a drive mechanism is displaced in the directional information predetermined by the laser line 22, beginning at the first equipment unit 10 acting as a base unit, until a desired spacing is reached. By means of the marking unit 34, the required position can be marked at the desired point. Besides the marking unit 34 as shown in FIGS. 1 and 2, which comprises merely an opening in the device through which suitable marking means can be placed on the surface of the reference face, marking means are also possible in alternative embodiments, such as dies that are integrated with the equipment unit 12, or integrated ink jets which analogously to an inkjet printer apply a spot of ink mechanically, electronically, thermally, pneumatically, or piezoceramically onto the position intended for the marking.

Besides the mechanical determination, described in the exemplary embodiment of the device of the invention in FIG. 1 and FIG. 2, of the spacing between the drive mechanism 12 and the base unit 10 and thus between the two positions that are to be marked, this spacing can also be determined optomechanically, for instance, analogously to a scrolling wheel of a computer mouse, via an ultrasound distance measurement, or via a distance measurement based on electromagnetic radiation, such as a laser distance meter or a radar distance meter. To that end, there can be a suitable emitter of the distance measuring device in the first equipment unit 10 and an associated receiver of the distance measuring device in the second equipment unit 12. It is equally conceivable for the emitter and receiver to be accommodated in the base unit of the first equipment unit 10, and to provide only a reflector for the measurement signal in the drive mechanism of the second equipment unit 12. Via a line connection that can be coiled up, the measurement and evaluation unit could also be provided in the first equipment unit 10, so that then only the display 32 would be embodied in the drive mechanism 12.

In alternative embodiments of the device of the invention, it may be provided that the second equipment unit 12 be implemented via a measuring tape or Bowden cable that is embodied in the first equipment unit 10 and can be pulled out and that in each case can be pulled out as far as the position of an intended bore, for instance, and the current spacing between the reference marking and the desired second marking can be shown via a display, for instance a digital display, on the measuring tape itself or on the stationary first equipment unit 10. In the case of a Bowden cable or a measuring string, the length between the base station, that is, the first equipment unit 10, and the remote end, relative to the base station 10, of the Bowden cable, which in this embodiment corresponds to the second equipment unit 12, can be reproduced via an output, for instance an optical or acoustical output of the first equipment unit 10. There is no need for a distance scale on the Bowden cable.

The device of the invention may also be embodied in such a way that this kind of measuring tape or measuring string in the form for instance of a Bowden cable is not embodied in the stationary equipment unit 10 but rather in the traveling element 12 and can be secured to the base station 10 via suitable connecting means.

Besides the use of a linear laser 20, described in conjunction with the exemplary embodiment of FIG. 1 and FIG. 2, which projects a laser line 22 onto the surface of a reference face 16, in a further feature of the device of the invention it may be advantageous to use a laser pointer. This laser, which generates a focused fine beam, can project a point onto the retractable extra module of the second equipment unit 12 that corresponds to a marking, such as the impression of a crosshair on the second equipment unit 12. If the second equipment unit 12 is then moved exactly parallel to the first equipment unit 10, then the point-shaped light signal emitted by the first equipment unit 10 remains at the intersection point of the crosshair of the traveling module 12. Deviations from the directional information emitted by the first equipment unit 10 by means of the laser pointer are made visible by a migration of the laser spot relative to the crosshair. This kind of embodiment of the optical signal means for generating directional information has the advantage that unevenness of the reference face, such as the wall, is less bothersome, since the predetermined travel distance is not projected via the reference face but instead is transmitted directly from the base unit 10 to the drive mechanism 12.

In a further advantageous option, the laser pointer that furnishes the optical signal means for generating the directional information can simultaneously be used for optically measuring the spacing between the base unit 10 and the drive mechanism 12, by modulating the laser signal such that by measuring the transit time or by phase evaluation, the distance between the drive mechanism 12 and the base unit 10 can be ascertained.

In a further feature of the device of the invention, in which once again a laser pointer is used as the optical signal means for generating directional information, instead of a target impression on the second equipment unit, a light-sensitive sensor area can be embodied on this equipment unit. This light-sensitive sensor face is embodied for instance as a PSD (position-sensitive detector) and can be implemented for instance in the form of a CCD (charge-coupled device) or a CMOS sensor. In the middle of such a sensor, the spotlike laser beam then ideally has the position 0,0 (in 2-D sensors), or 0 (in 1-D sensors). If a user, instead of moving the drive mechanism 12 parallel over the reference face, then moves it in serpentine lines over a wall, so that the measured distance is indicated as greater than the actual distance covered, then the PSD can on the one hand send acoustical and/or optical warning signals to the user, and moreover, errors in the spacing determination resulting from the nonparallel travel can be mathematically corrected, since the deviation over the distance traveled and the deviation at the laser spot from the PSD center X, 0 can be calculated.

FIG. 3 shows an alternative embodiment of the device of the invention, with an optical spacing sensor. The device of FIG. 3 comprises a stationary equipment unit 10, of the kind already described in conjunction with the device of FIG. 1 and FIG. 2. The first equipment unit 10 of the device of the invention in FIG. 3 has corresponding means for leveling the unit, such as the calibration means 24, described in conjunction with FIG. 1, that are in the form of bubble levels. The first equipment unit 10 also has one, two, or more lasers 54, 62, 64, which are capable of predetermining corresponding directional information. In particular, a laser signal 50 is oriented obliquely to the surface 52 of the reference face 16. This can for instance, as shown in FIG. 3, be implemented by providing that the light 50 emitted by a laser 54 is emitted at an angle to the reference face 16 that is other than zero.

The second equipment unit 13 of the device of the invention shown in FIG. 3 has an optical detector 56, such as a light-sensitive diode array 58, which determines the relative position Y of the laser signal 50 of the laser 54. Since the angle of the light signal 50 to the wall is known, it is possible via corresponding trigonometric functions to determine the spacing X of the second equipment unit 13′ relative to a zero position of the second equipment unit 13, or in a corresponding way the current spacing X′ of a marking unit 68 of the second equipment unit 13 can be defined relative to the position of the first equipment unit 10 and thus to a reference position 18. A second laser signal 60 originating at a laser 62 is helpful as a reference signal, especially with uneven walls, but in principle can also be omitted.

Advantageously, it is also possible in the device of the invention shown in FIG. 3 to use a single linear laser 64, which both serves as optical signal means for generating the directional information and, over the width of the laser beam, furnishes spacing information to the stationary equipment unit 10. To that end, instead of the laser 62, a laser 64 can be used which is embodied as a dash or linear laser and casts a corresponding line 66 onto the surface 52 of the reference face 16. If the second equipment unit 13 or 13′ is now displaced along the surface 52 of the reference face 16, then by means of a two-dimensional or linear optical detector 56, the lateral extent of the laser beam 66 can be ascertained at every location X. With the knowledge of the opening angle of the dashlike laser beam 66, from its cross-sectional dimension the applicable spacing from the generating laser source 64 and thus the spacing from the first equipment unit 10 can be ascertained.

The device 13 or 13′ has corresponding marking means 68, of the kind discussed and recited, but not exhaustively, in the description of the exemplary embodiment of FIG. 1 and FIG. 2, for instance.

The device for positioning markings of the invention is not limited to the exemplary embodiments shown in the drawings.

In particular, the device of the invention is not limited to positioning drill holes.

1. A device for positioning markings, having a first equipment unit (10), having means (14) for disposing the first equipment unit (10) at a predeterminable first position (18) of a reference face (16), and having optical signal means (20, 22, 50, 54, 60, 62, 64, 66) for generating directional information, characterized in that the device has a second equipment unit (12, 13), which is positionable relative to the first equipment unit (10) and which has means (20, 22, 28, 50, 54, 60, 62, 64, 66), which make it possible to ascertain the spacing of the second equipment unit (12,13) from the first equipment unit (10) in the direction predetermined by the first equipment unit.

2. The device as defined by claim 1, characterized in that the spacing determining means (20, 22, 28, 50, 54, 60, 62, 64, 66) include an optical measuring system.

3. The device as defined by claim 2, characterized in that the optical measuring system for determining spacing includes optical signal means (20, 22, 50, 54, 60, 62, 64, 66) of the first equipment unit (10).

4. The device as defined by claim 2, characterized in that the optical measuring system for determining spacing includes at least one light-sensitive sensor (56, 58).

5. The device as defined by claim 1, characterized in that the optical signal means (20, 22, 50, 54, 60, 62, 64, 66) include at least one laser (20, 54, 62, 64).

6. The device as defined by claim 1, characterized in that the first equipment unit (10) has means (24) which make it possible to level the optical signal means (20, 22, 50, 54, 60, 62, 64, 66), for generating directional information, relative to the reference face (16).

7. The device as defined by claim 1, characterized in that the optical signal means (20, 22, 50, 54, 60, 62, 64, 66) are self-leveling.

8. The device as defined by claim 1, characterized in that the spacing determining means include a mechanical measuring system (28).

9. The device as defined by claim 8, characterized in that the mechanical measuring system for determining spacing includes a travel pickup (28) connected to the second equipment unit (12).

10. The device as defined by claim 1, characterized in that the spacing determining means include a radar measuring system.

11. The device as defined by claim 1, characterized in that the device (10, 12, 13) has display means (32), which permit it to reproduce the spacing value of the second equipment unit (12, 13) from the first equipment unit (10).

12. The device as defined by one of the foregoing claims claim 1, characterized in that the second equipment unit (12, 13) has marking means (34, 68), which make it possible to mark a second position on the reference face (16) which corresponds to the ascertained spacing from the predeterminable first position in the direction predetermined by the first equipment unit (10).
